(19) United States
(12) Patent Application Publication
(10) Pub. No.: US 2014/0279399 A1
(43) Pub. Date: Sep. 18, 2014

(54) SYSTEM AND METHOD FOR MATCHING VENDORS AND CLIENTS

(71) Applicant: Capital One Financial Corporation, McLean, VA (US)

(72) Inventors: Kyle D. SHIDLER, Plano, TX (US); Regina ALMEYDA-DURAN, Dallas, TX (US); Wyatt D. MORDECAI, Fairview, TX (US); Caroline Q. MCNALLY, Dallas, TX (US); Kelley A. MCCLAIN, Frisco, TX (US); Anitha SRINIVASAN, Irving, TX (US); James Douglas SLADE, Highland Village, TX (US)

(73) Assignee: Capital One Financial Corporation, McLean, VA (US)

(21) Appl. No.: 14/211,126

(22) Filed: Mar. 14, 2014

Related U.S. Application Data
(60) Provisional application No. 61/783,161, filed on Mar. 14, 2013.

(51) Int. Cl. G06Q 40/02

(52) U.S. Cl. CPC G06Q 40/025
USPC 705/38

(57) ABSTRACT

A system and method for providing same-day funding to a vendor of a sale from a financial institution including the substantially real-time procedures of applying for funding, processing of the application, and providing same-day funding. The system and methods also including utilizing an open exchange platform for data communication and processing between a vendor system and a financial institution system. The same-day funding including an initial assessment and processing to determine if an application is eligible for same-day funding followed by further assessments and processing of application data where it is determined that the application is eligible for same-day funding.

### CROSS-REFERENCE TO RELATED APPLICATIONS

This application claims priority to U.S. Provisional Patent Application No. 61/783,161, filed Mar. 14, 2013, the entire contents of which is incorporated herein by reference.

This application contains subject matter related to U.S. Pat. No. 8,364,585, entitled “Same-Day Settlement of Financial Transactions, issued on Jan. 29, 2013, the entire contents of which is incorporated herein by reference.

### FIELD OF THE DISCLOSURE

The present disclosure relates to a system and method for a funding solution concerning a vendor system and a financial institution system.

### BACKGROUND OF THE DISCLOSURE

Current methods and systems for a sales transaction that involves financing are time consuming and often lengthy. The process includes, for example, a customer signing a contract, a vendor mailing the contract and associated documents to a third party for imaging and data entry, the third party processing the contract and documents, and a notification being sent to the vendor. One the notification is sent, the financing, e.g., funding or loan, is placed into the third party's accounting system so that funds may be disbursed to the vendor. The entire process takes approximately three to four days.

These and other drawbacks exist.

### SUMMARY OF THE DISCLOSURE

According to the various embodiments of the present disclosure, a vendor may transmit data elements from a vendor internal management system to a financial institution or financing system, through a third party, even before a customer signs a contract. The transmitted data elements may include data fields required by financial institutions to successfully complete funding. The third party, which may be an open exchange (OE) platform, may enable the data transfer.

Once the financial institution system receives the electronic funding data, the financial institution system may validate the data against the financial institution system's latest financing approval structure. If the financial institution system's latest approval structure and all required data elements match the data transmitted by the vendors, the financial institution system may send a funding notification to the vendor. The time period for this process may be as little as seconds after the transmission. The financial institution may then partner with another party to disburse funds to the vendor allowing the dealer to receive the requisite money on the same day as transmitting the request.

### BRIEF DESCRIPTION OF THE DRAWINGS

Various embodiments of the present disclosure, together with further objects and advantages, may best be understood by reference to the following description taken in conjunction with the accompanying drawings, in the several Figures of which like reference numerals identify like elements, and in which:

FIG. 1 depicts an example embodiment of a funding system according to an embodiment of the disclosure;

FIG. 2 depicts an example embodiment of funding method housed in the funding system according to an embodiment of the disclosure;

FIG. 3 depicts an example flow chart illustrating a method for receiving funding eligibility according to an embodiment of the disclosure;

FIG. 4 depicts an example flow chart illustrating open exchange validation according to an embodiment of the disclosure;

FIG. 5 depicts an example flow chart illustrating lender validation according to an embodiment of the disclosure;

FIG. 6 depicts an example flow chart illustrating funding and payment according to an embodiment of the disclosure;

FIG. 7 depicts an example system for enabling same-day funding according to an embodiment of the disclosure.

### DETAILED DESCRIPTION OF THE EMBODIMENTS

The following description is intended to convey a thorough understanding of the embodiments described by providing a number of specific example embodiments and details involving systems and methods for applying for funding, real-time processing of the application, and providing same-day funding.

It should be appreciated, however, that the present disclosure is not limited to these specific embodiments and details, which are examples only. It is further understood that one possessing ordinary skill in the art, in light of known systems and methods, would appreciate the use of the invention for its intended purposes and benefits in any number of alternative embodiments, depending on specific design and other needs. A vendor, financial institution, third party, and/or open exchange and system supporting a connection between vendors, financial institutions, customers, third parties, and/or open exchange are used as examples for the disclosure. The disclosure is not intended to be limited to vendors, financial institutions, customers, open exchanges, and third parties only.

The example embodiments disclosed herein are directed to systems and methods for providing an application for a sale, an analysis of the application, a determination of a funding status associated with the analyzed application, and a funding of the sale. For example, in an automobile sales transaction, the example systems and methods described herein may provide an application for same-day funding an automobile loan. These systems and methods may, for example, include and/or cooperate with an Open Dealer Exchange or the like and other systems to enable an auto finance institution to on-board and fund auto-loans on the same day. Though the examples described herein relate to, for example, an automobile sales transaction, other similar sales transactions that may involve financing are contemplated. For example, the systems and methods described herein may apply to financed purchases at big-box retailers, furniture stores, heavy equipment dealers, power sports equipment dealers and/or the like.

According to the various embodiments of the present disclosure, a vendor may receive customer and/or financial institution data over a network via a provider. Additionally, a financial institution may receive customer and/or vendor data over a network via a provider. An open exchange platform may also receive financial institution, customer, and/or vendor data over a network via a provider. The provider may be a financial institution, a social networking site, an open exchange, or a third-party provider. The vendor, customer, financial institution and other data such as third-party data may be associated with an account with a financial institution held by an account holder.

An account may include any place, location, object, entity, or other mechanism for holding money or performing transactions in any form, including, without limitation, electronic form. An account may be, for example, a credit card account, a prepaid card account, stored value card account, debit card account, check card account, payroll card account, gift card account, prepaid credit card account, charge card account, checking account, rewards account, line of credit account, credit account, an auto loan account, or a lending account. A financial institution may be, for example, a bank, other type of financial institution, including an auto finance provider, for example, or any other entity that offers accounts to customers.

Data used in the various embodiments may include customer data, dealer and/or vendor data, third-party data, and financial institution data. Customer data may include data relating to customer needs including, without limitation, loan type, loan amount, application type, loan term, customer name, customer address, customer residency information, customer telephone information, customer email information, customer employment information, customer income information, customer social security, customer date of birth, and customer vehicle information, such as vehicle model and make information, mileage information, and the like. The vendor data may include data relating to vendor industry, vendor location, vendor services, vendor goods, vendor financial information, vendor approval information, vendor-financial institution preferred status, and the like. The financial institution data may include data relating to vendor relationship information, interest rate information, loan term information, and funding information.

FIG. 1 depicts an example embodiment of a funding system 100. Funding system 100 may include various systems connected to each other over a network 110. These systems include a vendor internal management system 120, a financial institution system 140, and an open exchange (OE) platform 130. By way of example, a funding system 100 may provide vendors, financial institutions, and third parties with the opportunity for vendors or third parties to provide customer funding/financing approval, while receiving the necessary funds from a third party or financial institution in an expedited procedure.

The network 110 may be one or more of a wireless network, a wired network, or any combination of a wireless network and a wired network. For example, network 110 may include one or more of a fiber optics network, a passive optical network, a cable network, an Internet network, a satellite network, a wireless LAN, a Global System for Mobile Communication (GSM), a Personal Communication Service (PCS), a Personal Area Networks, (PAN), D-AMPS, Wi-Fi, Fixed Wireless Data, IEEE 802.11b, 802.15.1, 802.11n, and 802.11g or any other wired or wireless network for transmitting and receiving a data signal.

In addition, network 110 may include, without limitation, telephone lines, fiber optics, IEEE Ethernet 902.3, a wide area network (WAN), a local area network (LAN) or a global network such as the Internet. Also, network 110 may support an Internet network, a wireless communication network, a cellular network, or the like, or any combination thereof. Network 110 may further include one network, or any number of example types of networks mentioned above, operating as a stand-alone network or in cooperation with each other. Network 110 may utilize one or more protocols of one or more network elements to which they are communicatively couples. Network 110 may translate to or from other protocols to one or more protocols of network devices. Although network 110 is depicted as a single network, it should be appreciated that according to one or more embodiments, network 110 may comprise a plurality of interconnected networks, such as, for example, the Internet, a service provider's network, a cable television network, corporate networks, and home networks.

A financial institution may access network 110 through one or more financial institution systems 140 that may be communicatively coupled to the network 110. A vendor may access the network 110 through one or more vendor internal management systems 120 that may be communicatively coupled to the network 110. One or more open exchange platforms 130 may also be communicatively coupled to the network 110. A wire system 160 may also be communicatively coupled to the network 110.

An example vendor internal management system 120, financial institution system 140, and wire system 160 may include one or more network-enabled computers to process instructions for substantially real-time funding procedures that result in same-day funding 200. As referred to herein, a network-enabled computer may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. The one or more network-enabled computers of the example same-day funding system 100 may execute one or more software applications to, for example, receive data as input from an entity accessing the network-enabled computer, process received data, transmit data over a network 110, and receive data over a network 110. The one or more network-enabled computers may also include one or more software applications to enable the processing of same-day funding.

The vendor internal management system 120, financial institution system 140, open exchange platform 130, and wire system 160 may further include, for example, a processor, which may be several processors, a single processor, or a single device having multiple processors. The vendor internal management system 120, financial institution system 140, open exchange platform 130, and wire system 160 may access and be communicatively coupled to the network 110. The vendor internal management system 120, financial institution system 140, open exchange platform 130, and wire system 160 also may store information in various electronic storage media, such as, for example, a database (not shown). Electronic information may be stored in the vendor internal management system 120, financial institution system 140, open exchange platform 130, and wire system 160 in a format such as, for example, a flat file, an indexed file, a hierarchical database, a post-relational database, a relational database, such as a database created and maintained with software from, for example Oracle® Corporation, Microsoft® Excel file, Microsoft® Access file, or any other storage mechanism.

The vendor internal management system 120, financial institution system 140, open exchange platform 130, and wire system 160 may send and receive data using one or more protocols. For example, data may be transmitted and received using Wireless Application Protocol (WAP), Multimedia Messaging Service (MMS), Enhanced Messaging Service (EMS), Short Message Service (SMS), Global System for Mobile Communications (GSM) based systems, Time Division Multiplexing (TDM) based systems, Code Division Multiples Access (CDMA) based systems suitable for transmitting and receiving data. Data may be transmitted and received wirelessly or may utilize cabled network connections or telecom connections, fiber connections, traditional phone wireline connection, a cable connection, or other wired network connection.

Each of the vendor internal management system 120, financial institution system 140, open exchange platform 130, and wire system 160 depicted in FIG. 1 may also be equipped with physical media, such as, but not limited to, a compact disc (CD), a digital versatile disc (DVD), a floppy disk, a hard drive, read only memory (ROM), random access memory (RAM), as well as other physical media capable of storing software, or combinations thereof. The vendor internal management system 120, financial institution system 140, open exchange platform 130, and wire system 160 may be able to perform the functions of the funding procedure 200 and may, for example, house the software of the funding procedure 200, obviating the need for a separate device on the network 110 to run the methods housed on the vendor internal management system 120, financial institution system 140, open exchange platform 130, and wire system 160. Furthermore, the information stored in a database (not shown) may be available over the network 110, with the network containing data storage.

A database housed on any of the vendor internal management system 120, financial institution system 140, open exchange platform 130, and wire system 160 or the network 110, may store, or may connect to external data warehouses that stores, customer data, vendor data, financial institution data, and third party data. Such data, detailed below, may be accessed by the funding procedure 200, in order to provide substantially real-time funding.

In various example embodiments, the vendor utilizing the vendor internal management system 120 may be any individual or entity that desires to conduct a financial transaction with the financial institution accessible through the financial institution system 140. For example, the vendor may desire to solicit customer funding from a financial institution in order to finance a customer purchase. By way of example, this purchase may be for an automobile and the funding may be in the form of an auto loan. In this example, the vendor internal management system 120 may be a dealer internal management system, including, for example, an auto dealer management system or like bundled management information system that may be created for a dealer, large equipment manufacturer, big box retailer and the like and may be adapted for the sale of cars, boats, recreational vehicles, power sports, furniture, heavy equipment, consumer electronics and/or the like. These management information systems may contain modules including hardware, software and/or firmware that enables sales, finance, parts, inventory, and administration of, for example, a vendor. These systems also may include a central server which may store data and allow multi-user access. Furthermore, in this example, the financial institution system 140 may be an auto finance system that provides auto loans to customers on behalf of dealers, such as Capital One Auto Finance. Lastly, in this example, the open exchange platform 130 may be specific for automotive financing, such as Open Dealer Exchange.

FIG. 7 depicts an example system 700 that may enable a financial institution, for example, to provide network services to its customers. System 700 also may enable, for example, vendor management systems and open dealer exchanges as described herein. As shown in FIG. 7, system 700 may include a client device 702, a network 704, a front-end controlled domain 706, a back-end controlled domain 712, and a backend 718. Front-end controlled domain 706 may include one or more load balancers 708 and one or more web servers 710. Back-end controlled domain 712 may include one or more load balancers 714 and one or more application servers 716.

Client device 702 may be a network-enabled computer: As referred to herein, a network-enabled computer may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. The one or more network-enabled computers of the example system 700 may execute one or more software applications to enable, for example, network communications.

Client device 702 also may be a mobile device: For example, a mobile device may include an iPhone, iPod, iPad from Apple® or any other mobile device running Apple's iOS operating system, any device running Google's Android® operating system, including for example, Google's wearable device, Google Glass, any device running Microsoft's Windows® Mobile operating system, and/or any other smartphone or like wearable mobile device.

Network 704 may be one or more of a wireless network, a wired network, or any combination of a wireless network and a wired network. For example, network 704 may include one or more of a fiber optics network, a passive optical network, a cable network, an Internet network, a satellite network, a wireless LAN, a Global System for Mobile Communication (GSM), a Personal Communication Service (PCS), a Personal Area Networks, (PAN), D-AMPS, Wi-Fi, Fixed Wireless Data, IEEE 802.11b, 802.15.1, 802.11n, and 802.11g or any other wired or wireless network for transmitting and receiving a data signal.

In addition, network 704 may include, without limitation, telephone lines, fiber optics, IEEE Ethernet 902.3, a wide area network (WAN), a local area network (LAN) or a global network such as the Internet. Also, network 704 may support an Internet network, a wireless communication network, a cellular network, or the like, or any combination thereof. Network 704 may further include one network, or any number of example types of networks mentioned above, operating as a stand-alone network or in cooperation with each other. Network 704 may utilize one or more protocols of one or more network elements to which they are communicatively couples. Network 704 may translate to or from other protocols to one or more protocols of network devices. Although network 704 is depicted as a single network, it should be appreciated that according to one or more embodiments, network 704 may comprise a plurality of interconnected networks, such as, for example, the Internet, a service provider's network, a cable television network, corporate networks, and home networks.

Front-end controlled domain 706 may be implemented to provide security for backend 718. Load balancer(s) 708 may distribute workloads across multiple computing resources, such as, for example computers, a computer cluster, network links, central processing units or disk drives. In various embodiments, load balancer(s) 710 may distribute workloads across, for example, web server(S) 716 and/or backend 718 systems. Load balancing aims to optimize resource use, maximize throughput, minimize response time, and avoid overload of any one of the resources. Using multiple components with load balancing instead of a single component may increase reliability through redundancy. Load balancing is usually provided by dedicated software or hardware, such as a multilayer switch or a Domain Name System (DNS) server process.

Load balancer(s) 708 may include software that monitoring the port where external clients, such as, for example, client device 702, connect to access various services of a financial institution, for example. Load balancer(s) 708 may forward requests to one of the application servers 716 and/or backend 718 servers, which may then reply to load balancer 708. This may allow load balancer(s) 708 to reply to client device 702 without client device 702 ever knowing about the internal separation of functions. It also may prevent client devices from contacting backend servers directly, which may have security benefits by hiding the structure of the internal network and preventing attacks on backend 718 or unrelated services running on other ports, for example.

A variety of scheduling algorithms may be used by load balancer(s) 708 to determine which backend server to send a request to. Simple algorithms may include, for example, random choice or round robin. Load balancers 708 also may account for additional factors, such as a server's reported load, recent response times, up/down status (determined by a monitoring poll of some kind), number of active connections, geographic location, capabilities, or how much traffic it has recently been assigned.

Load balancers 708 may be implemented in hardware and/or software. Load balancer(s) 708 may implement numerous features, including, without limitation: asymmetric loading; Priority activation: SSL Offload and Acceleration; Distributed Denial of Service (DDoS) attack protection; HTTP compression; TCP offloading; TCP buffering; direct server return; health checking; HTTP caching; content filtering; HTTP security; priority queuing; rate shaping; content-aware switching; client authentication; programmatic traffic manipulation; firewall; intrusion prevention systems.

Web server(s) 710 may include hardware (e.g., one or more computers) and/or software (e.g., one or more applications) that deliver web content that can be accessed by, for example a client device (e.g., client device 702) through a network (e.g., network 704), such as the Internet. In various examples, web servers, may deliver web pages, relating to, for example, online banking applications and the like, to clients (e.g., client device 702). Web server(s) 710 may use, for example, a hypertext transfer protocol (HTTP or sHTTP) to communicate with client device 702. The web pages delivered to client device may include, for example, HTML documents, which may include images, style sheets and scripts in addition to text content.

A user agent, such as, for example, a web browser, web crawler, or native mobile application, may initiate communication by making a request for a specific resource using HTTP and web server 710 may respond with the content of that resource or an error message if unable to do so. The resource may be, for example a file on stored on backend 718. Web server(s) 710 also may enable or facilitate receiving content from client device 702 so client device 702 may be able to, for example, submit web forms, including uploading of files.

Web server(s) also may support server-side scripting using, for example, Active Server Pages (ASP), PHP, or other scripting languages. Accordingly, the behavior of web server(s) 710 can be scripted in separate files, while the actual server software remains unchanged.

Load balancers 714 may be similar to load balancers 708 as described above.

Application server(s) 716 may include hardware and/or software that is dedicated to the efficient execution of procedures (e.g., programs, routines, scripts) for supporting its applied applications. Application server(s) 716 may comprise one or more application server frameworks, including, for example, Java application servers (e.g., Java platform, Enterprise Edition (Java EE), the .NET framework from Microsoft®, PHP application servers, and the like). The various application server frameworks may contain a comprehensive service layer model. Also, application server(s) 716 may act as a set of components accessible to, for example, a financial institution or other entity implementing system 700 through an API defined by the platform itself. For Web applications, these components may be performed in, for example, the same running environment as web server(s) 710, and application servers 716 may support the construction of dynamic pages. Application server(s) 716 also may implement services, such as, for example, clustering, fail-over, and load-balancing. In various embodiments, where application server(s) 716 are Java application servers, the web server(s) 716 may behaves like an extended virtual machine for running applications, transparently handling connections to databases associated with backend 718 on one side, and, connections to the Web client (e.g., client device 702) on the other.

Backend 718 may include hardware and/or software that enables the backend services of, for example, a financial institution or other entity, such as a vendor management system or open dealer exchange, that maintains a distributed system similar to system 700. For example, backend 718 may include, a system of record, online banking applications, a rewards platform, a payments platform, a lending platform, including the various services associated with, for example, auto and home lending platforms, a statement processing platform, one or more platforms that provide mobile services, one or more platforms that provide online services, a card provisioning platform, a general ledger system, and the like. Backend 718 also may include various vendor platforms that maintain, for example, inventory and enable management of various services provided by a vendor. Backend 718 may be associated with various databases, including account databases that maintain, for example, customer account information, product databases that maintain information about products and services available to customers, content databases that store content associated with, for example, a financial institution, and the like. Backend 718 also may be associated with one or more servers that enable the various services provided by system 700.

FIGS. 2 through 6 illustrates an example procedures for an application for a sale, an analysis of the application, a determination of a funding status associated with the analyzed application, and a funding of the sale. For example, a vendor may begin the funding procedure 200 by submitting the customer(s) (or application(s)) information 210. This information includes customer data, such as, data relating to customer needs including loan type, loan amount, application type, loan term, customer name, customer address, customer residency information, customer telephone information, customer email information, customer employment information, customer income information, customer social security, customer date of birth, customer credit information, customer vehicle information, and the like. This data may be submitted using an application 212 sent through the vendor internal management system 120. The financial institution system 140 may then receive application 214. The application may be submitted via a third-party system. By way of example, third-party systems may be third-party systems associated with the automobile industry, such as DealerTrack or Route One. Once the application is received 214 by the financial institution system 140, the financial institution system 140 may evaluate the application against the financial institution's credit risk and pricing modules to determine if the application is preliminarily approved or declined 216.

In addition to evaluating the application against the financial institution's credit risk and pricing modules 216, the financial institution system 140 may check the application against a series of rules to determine if the application is eligible for same-day funding 220. The rules may be comprised of rules related to the application and/or vendor-specific rules. The financial institution system 140 may require that each application and vendor pass every rule in order to determine that an application is eligible for same-day funding 220. In the instance where an application or Vendor does not meet the same-day eligibility requirements of the financial institution system 140, a notification or callback may be sent to the vendor internal management system 120 along with instructions on how to proceed with a declined same-day funding application. In the instance where an application or vendor does meet the same-day funding eligibility requirements of the financial institution system 140, a same-day funding callback may be transmitted 230 to the dealer internal management system 120. The same-day funding callback 230 may include an indicator that signals to the dealer internal management system 120 that the application is eligible for same-day funding. For the purposes of this application, same-day funding may include funding or financing that allows a vendor to receive requested funds in an account associated with that vendor at any time within a 24 hour period of that request.

In the event that an application and/or vendor are eligible for same-day funding, the funding system 100 may proceed with open exchange validation 240. Open exchange validation may include a selection by the vendor internal management system 120, or allow for manual selection, of the financial institution associated with the financial institution system 140 that approved the application and vendor for same-day funding 241. This selection 241 may indicate that the financial institution system 140 may be the buyer associated with the same-day funding and may contain a signal indicating the application will be processed as a same-day funding application. The vendor internal management system 120 may further select, or provide an interface for manual selection of, a contract type command, including Contract Validation (CV) 242 or Contract Funding (CF) 243.

The CV 242 command in the vendor internal management system 120 may indicate that upon lender validation 250, the financial institution system 140 may transmit a signal or notification to the Vendor Internal Management System 120 that a sale is eligible for same-day funding and that the vendor has decided to fund the contract with the financial institution system 140. The signal or notification transmitted by the financial institution system 140 may further send a verification that the electronic funding data is complete, accurate and validates against the financial institution system's latest approval structure.

The CF 243 command in the vendor internal management system 120 may signal that, upon lender validation 250 of the contract, the vendor is ready to submit the contract for same-day funding. For example, under the CF 243 command, once a vendor has finalized a contract, passed all non-lender and lender-specific files, chosen the financial institution system 120 as the lien holder, and the customer is ready to sign or has signed the contract, the financial institution system 140 may then send a notification to the vendor internal management system 120 that the submission of the application was successful and the sale has been funded.

By providing a selection of a contract type 242, 243, the vendor internal management system may signal or send a notification indicating an initiation of a same-day funding process 244. The signal of the initiation 244 may then generate a data transmission 245 from the vendor internal management system 120 to the open exchange platform 130 via the network 110. Transmitted data may include vendor data, customer data, financial institution data, third party data, application data, and/or the like.

The open exchange platform 130 may then assess and analyze the transmitted data against non-lender specific rules 246. Non-lender specific rules may include rules that are not specific to any particular financial institution or financial institution system 140 that may be providing or transmitting data associated with the same-day funding. The open exchange analysis 246 may validate that the vendor, through the vendor internal management system 120, has provided all data correctly. For example, the open exchange analysis 246 may ensure that there are no characters in the social security field of the application, that the calculations associated with the data are processed correctly, and/or that no required data is missing. If the transmitted data fails the open exchange analysis 246, a notification may be sent to the vendor internal management system 120. The notification sent to the vendor internal management system 120 may include a prompt that allows the vendor, or the vendor internal management system 120, to make any necessary corrections. The open exchange platform 130 may include logic to prevent transmission of any data to the financial institution system 140 until all data has successfully passed the open exchange's validation rules. Following an analysis of the application 246 at the open exchange platform 130, the data may then be transmitted 247 from the open exchange platform 130 to the financial institution system 140 via the network 110 in order to begin lender validation 250.

FIG. 5 illustrates lender validation 250, which may begin with a match eligibility process 251 run in the financial institution system 140. A match eligibility process 251 may attempt to match the data received from the open exchange platform 130 to the financial institution system 140 existing approval for the particular application associated with the data. In attempting to match the data, match eligibility 251 may provide a first pass prior to validating eligibility for same-day funding and all lender-specific riles. Match eligibility 251 may attempt to match criteria such as vendor identification data, approval status data, and customer data including line of business data and customer name data. It may then be determined if the match eligibility data or criteria has been validated 252.

If any of the criteria fails validation 252, the vendor internal management system 120 may be sent an error message 253. The error message 253 may include data indicating the criteria that failed in match eligibility validation. The vendor internal management system 120 may then provide, or allow for manual input of, corrections to the criteria 254. Once corrections have been made, the data may then be transmitted back to the open exchange platform 130 for resubmission to match eligibility 251. The data may continue to flow through match eligibility 251 and validation 252 until all criteria matches.

If the criteria passes validation 252, the open exchange platform 130 may transmit the data to the financial institution system 140 via the network 110 for a same-day eligibility check 255. If the application data indicates that the application is eligible for same-day funding, the application data may then proceed to a validation of requirements 256 in the financial institution system 140. A validation of requirements 256 validates the application data and criteria against financial institution specific rules. For example, financial institution specific rules may include credit policies, pricing rules, and/or tolerance rules to verify that there are no credit policy violations.

If the application data has passed all matching and validation rules, the financial institution system 140 may also determine if the application data includes a CV 242 request or a CF 243 request 256. If the application data includes a CV 242 request, the financial institution system 140 may transmit a notification to the vendor internal management system 120 that indicates a successful validation 257. If the application data includes a CF 243 request, the financial institution system 140 transmit a notification to the vendor internal management system 120 that indicates a sale “funded” 258.

Once the financial institution system 140 has notified the vendor internal management system 120 that the contract has been successfully validated and/or same-day funded, funding system 100 may initiate same-day funding 260. During the initiation of same-day funding 260, the vendor internal management system 120 may change a status of the contract from pending to indicate the approval status of the contract 262. For example, the contract status may change to “Paid Pre-Funded,” “Approved,” “CF Approved,” “CV Approved,” or the like. This change in status may then trigger 264 the payment process 270.

Once the same-day payment process trigger 264 executes, the funding system 100 may begin the same-day payment process 270. The same-day payment process 270 may begin with the financial institution system 140 transmitting the pre-funded contract data to a general ledger module 150 where the contract data will be posted and reconciled 272. Once the proper payment amounts have been posted 272, the financial institution system 140 may create, or display an interface to allow a user to create, a wire transfer file and transmit data to a wire system 160 for processing and posting 274.

In an example embodiment, the wire system 160 may be a system internal to the financial institution system 140 that is used to transmit and receive wire requests to the Federal Reserve, or the like. The Federal Reserve may then pass the request on to a receiver, which may be a receiving bank, based on the information provided in the request. In various examples, the same-day funding systems and methods shown and described in U.S. Pat. No. 8,364,585, entitled “Same-Day Settlement of Financial Transactions”, the entire contents of which is incorporated herein by reference, may be used.

Once the wire system 160 has processed and posted the wire transfer file 274, the vendor, through the vendor internal management system 120, may receive the funds in an account. This receipt of funds may be within a couple of hours from the submission of the application. In some cases, the vendor may receive funding within thirty minutes of having submitted a CF 243 request to the financial institution system 140.

It should be appreciated that the foregoing discussion related to FIGS. 1 through 7 is illustrative only, and that the various embodiments of the invention may be implemented by any other appropriate system or method.

In the preceding specification, various preferred embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

1. A vendor management system comprising:
a computer connectively coupled to a network, the computer including a processor that:
submits an application for same-day funding of a sale to a financial institution system;
receives a notification indicating whether the application is eligible for same-day funding; and
receives funding from the financial institution system in an account to fund the sale on the same day that the application was submitted based on a determination by the financial institution that the application is eligible for same day funding.

2. The vendor management system of claim 1, wherein the processor further receives instructions for processing a declined same-day funding application based on a determination by the financial institution that the application is not eligible for same day funding.

3. The vendor management system of claim 1, wherein the processor further transmits application data to an open exchange system via a network, wherein the open exchange system performs a preliminary validation of the application data before transmitting the application data to the financial institution system.

4. The vendor management system of claim 1, wherein the processor further transmits a request to the financial institution system indicating an application type when the application is eligible for same-day funding, the application type selected from: contract validation and contract funding.

5. A financial institution system comprising:
a communication receiver module that receives, via a network, an electronic application from a vendor management system, the electronic application including data elements;
a processor that executes a first evaluation of the data elements against data elements associated with a credit risk and a pricing model to determine a preliminary application status; and
a communication transmit module that transmits, via a network, the preliminary application status, the preliminary application status including an indicator which indicates whether the application is eligible for same-day funding.

6. The financial institution system of claim 5, wherein the first evaluation further includes an evaluation of the electronic application data elements against data elements associated with vendor-specific rules to determine the preliminary application status.

7. The financial institution system of claim 5, wherein the communication receiver module receives, from an open exchange system via a network, pre-certified application data, and wherein the processor matches the pre-certified application data to the financial institution system's existing approval of the same day eligible application.

8. The financial institution system of claim 7, wherein the processor further matches initial data fields with the pre-certified application data, the initial data fields selected from: vendor identification, application approval status, applicant line of business, and applicant last name.

9. The financial institution system of claim 8, wherein the processor further transmits, via a network, a request for further information to the vendor management system if any of the initial data fields do not match the pre-certified application data.

10. The financial institution system of claim 9, wherein the processor further validates the pre-certified application data against at least one financial institution specific rule to yield a validated application data, wherein the at least one financial institution specific rule is selected from: a credit policy rule, a pricing rule, and a tolerance rule.

11. The financial institution system of claim 10, wherein the processor further:
determines an application type selected from: contract validation and contract funding; and
transmits, via a network, to the vendor management system, a notification of whether the application was successfully processed, wherein the notification is a first notification if it is determined that the application type is contract validation, and the notification is a second notification if it is determined that the application type is contract funding.

12. The financial institution system of claim 11, wherein the processor further alters application status data to indicate that an application has been approved for funding to return a pre-funded contract.

13. The financial institution system of claim 12, wherein the processor further transmits, via a network, to a general ledger module of the financial institution system, the pre-funded contract for reconciliation.

14. A method for same-day funding comprising the steps of:
submitting, via a network, from a vendor management system via a network, an application for same-day funding of a sale to a financial institution system;
receiving, at the vendor management system via the network, a notification indicating whether the application is eligible for same-day funding; and
transmitting, from the vendor management system via the network, a contract submission containing same-day funding data to an open exchange system, wherein the open exchange system performs a preliminary assessment of the application data before transmitting the application data to the financial institution system, and wherein the financial institution performs a secondary assessment of the application data; and
receiving, via the network, same-day funding in an account associated with the vendor management system to fund the sale based on a determination that the application data passes the preliminary assessment at the open exchange and the secondary assessment at the financial institution.

15. The method of claim 14 wherein the application data includes an application type selected from: contract validation and contract funding.

16. A method for same-day funding comprising the steps of:
receiving, at a financial institution system via a network, data associated with an application for same-day funding from a vendor management system via a network;
executing, using a computer processor associated with the financial institution system, a first evaluation of the application against a credit risk and a pricing module to determine a preliminary application status; and
transmitting the preliminary application status to the vendor management system via a network, the preliminary application status including a same-day funding indicator which indicates whether the application is eligible for same-day funding.

17. The method of claim 16, wherein the first evaluation further includes evaluation of the application against vendor-specific rules to determine the preliminary application status.

18. The method of claim 17, further comprising the steps of:
receiving, from an open exchange platform, pre-certified application data based on the preliminary application status;
matching the pre-certified application data to the financial institution system's existing approval of the application that is eligible for same-day funding; and
matching initial data fields with the pre-certified application data, the initial data fields selected from: vendor identification, application approval status, applicant line of business, and applicant last name.

19. The method of claim 18, further comprising the steps of:
transmitting, via a network, a request to the vendor management system if any of the initial data fields do not match the pre-certified application data.

20. The method of claim 19, further comprising the steps of
validating the pre-certified application data against at least one financial institution specific rule to yield validated application data, wherein the at least one financial institution specific rule is selected from: a credit policy rule, a pricing rule, and a tolerance rule;
determining an application type selected from: contract validation and contract funding; and
transmitting a notification of whether the same-day funding application was successfully processed, wherein the notification is a first notification if it is determined that the application type is contract validation, and the notification is a second notification if it is determined that the application type is contract funding.

21. The method of claim 20, further comprising the steps of:
altering application status data to indicate that an application has been approved for funding to return a pre-funded contract; and
transmitting, to a general ledger module of the financial institution system, the pre-funded contract for reconciliation.
